(19) United States
(12) Patent Application Publication
(10) Pub. No.: US 2014/0130740 A1
(43) Pub. Date: May 15, 2014

(54) PLASMA DEPOSITION APPARATUS

(71) Applicant: INDUSTRIAL TECHNOLOGY RESEARCH INSTITUTE, Hsinchu (TW)

(72) Inventors: Jui-Mei Hsu, Taichung City (TW); Chen-Der Tsai, Hsinchu County (TW); Jiuan-Ren Jei, Hualien County (TW); Ying-Fang Chang, Hsinchu City (TW); Chia-Chiang Chang, Taoyuan County (TW)

(73) Assignee: INDUSTRIAL TECHNOLOGY RESEARCH INSTITUTE, Hsinchu (TW)

(21) Appl. No.: 13/726,239

(22) Filed: Dec. 24, 2012

(30) Foreign Application Priority Data
Nov. 15, 2012 (TW) 101142682

(51) Int. Cl. B05C 9/02

(52) U.S. Cl. CPC B05C 9/02
USPC 118/722

(57) ABSTRACT

A plasma deposition apparatus including a plasma generation unit and a droplet separation unit is provided. The plasma generation unit includes an inlet end and an outlet end. The droplet separation unit is located at the inlet end. Besides, the droplet separation unit includes a first chamber, an import port, and a connection port. The import port and the connection port are connected to the first chamber. The connection port is connected to the inlet end, and the import port serves to receive an atomized precursor. The atomized precursor is separated into a first portion and a second portion after entering the first chamber, and droplets of the first portion are smaller than droplets of the second portion. The first portion of the atomized precursor is suitable for entering the inlet end through the connection port.

### CROSS-REFERENCE TO RELATED APPLICATION

This application claims the priority benefit of Taiwan application serial no. 101142682, filed on Nov. 15, 2012. The entirety of the above-mentioned patent application is hereby incorporated by reference herein and made a part of this specification.

### TECHNICAL FIELD

The disclosure relates to a plasma deposition apparatus.

### BACKGROUND

Plasma coating plays a decisive role in the existing industrial technologies. Typically, the coating technology may be classified into vapor deposition and liquid deposition. Vapor deposition mainly includes physical vapor deposition (PVD) and chemical vapor deposition (CVD); liquid deposition mainly includes solution deposition, electroplating, and so forth.

The plasma coating process is often performed in a vacuum environment and thus is characterized by various disadvantages. For instance, vacuum equipment is rather expensive and requires high maintenance costs; the dimension of substrate is subject to the size of the vacuum chamber, and the vacuum pumping procedure is time-consuming. In comparison with the vacuum plasma coating system, the atmospheric pressure plasma coating system does not require the vacuum environment and therefore is gradually employed in the flat-panel-display industry, the semiconductor industry, or in the photo-voltaic industry.

However, the plasma coating process implemented under the normal pressure is susceptible to the atmosphere of the environment, such that the environmental factors including pressure, temperature, humidity, and oxygen contents can barely be well-controlled. Thereby, it is rather difficult to manage the optical and electrical properties of the resultant films. Moreover, the atomized precursor required in the coating process may be condensed into droplets of large sizes via tube transmission. When the precursor droplets of large sizes enter the plasma deposition apparatus, precursor cannot be fully dissociated, and the resultant film may have unsatisfactory quality and appear particulate defects.

### SUMMARY

An exemplary embodiment of the disclosure is directed to a plasma deposition apparatus with a droplet separation unit.

In an exemplary embodiment of the disclosure, the plasma deposition apparatus includes a plasma generation unit and a droplet separation unit. The plasma generation unit includes an inlet end and an outlet end. The droplet separation unit is located at the inlet end of the plasma generation unit. Besides, the droplet separation unit includes a first chamber, an import port, and a connection port. The import port and the connection port are connected to the first chamber. The connection port is connected to the inlet end of the plasma generation unit, and the import port is configured to receive an atomized precursor. The atomized precursor is separated into a first portion and a second portion after entering the first chamber, and droplet size of the first portion of the atomized precursor is smaller than droplet size of the second portion of the atomized precursor. The first portion of the atomized precursor is suitable for entering the inlet end of the plasma generation unit through the connection port of the droplet separation unit.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic block diagram illustrating a plasma deposition apparatus according to an exemplary embodiment of the disclosure.

FIG. 2 illustrates a structure of a plasma deposition apparatus according to an exemplary embodiment of the disclosure.

FIG. 3 is an enlarged view of the droplet separation unit in FIG. 2.

FIG. 4 is a schematic diagram illustrating another droplet separation unit according to an exemplary embodiment of the disclosure.

FIG. 5 is an enlarged view of the plasma generation unit in FIG. 2.

FIG. 6 is an enlarged view of the air curtain unit in FIG. 1.

FIG. 7 is a bottom view of the air curtain unit in FIG. 6 along a direction D1.

FIG. 8 schematically illustrates a design of an air outlet of an air curtain unit according to another exemplary embodiment of the disclosure.

### DETAILED DESCRIPTION OF DISCLOSED EMBODIMENTS

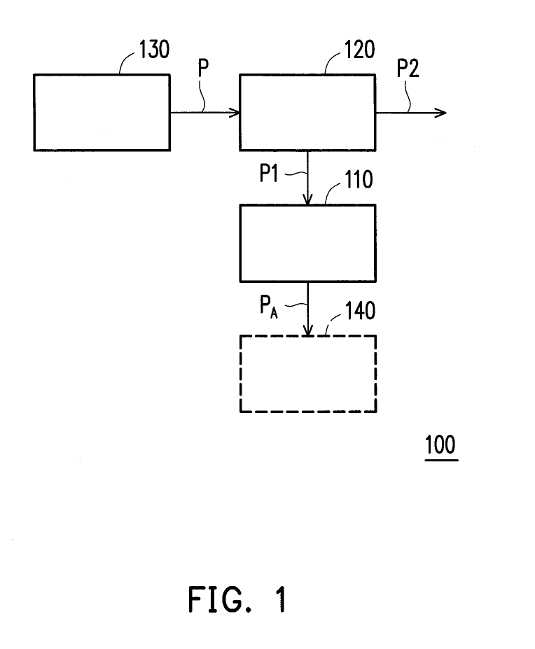

FIG. 1 is a schematic block diagram illustrating a plasma deposition apparatus according to an exemplary embodiment of the disclosure. With reference to FIG. 1, in this exemplary embodiment of the disclosure, the plasma deposition apparatus 100 includes a plasma generation unit 110, a droplet separation unit 120, and an atomizer 130. The atomizer 130 serves to generate an atomized precursor P from an aqueous solution or an organic solvent, and the atomized precursor P may be carried to the droplet separation unit 120 through carrier gas. Generally, the atomized precursor P may be condensed into droplets of large sizes during transmission. The droplet separation unit 120 is able to screen and separate the condensed large droplets. Large droplets of the atomized precursor P may be filtered out, and small droplets of the atomized precursor P are then allowed to enter the plasma generation unit 110. To be more specific, the droplet separation unit 120 may separate the atomized precursor P into a first portion P1 (containing small droplets) and a second portion P2 (containing large droplets). The first portion P1 of the atomized precursor P is guided to the plasma generation unit 110, while the second portion P2 of the atomized precursor P is filtered out by the droplet separation unit 120. In the plasma generation unit 110, the first portion P1 of the atomized precursor P may be dissociated by and incorporated into plasma PA. In the present exemplary embodiment, the vapor deposition technology (e.g., plasma enhanced chemical vapor deposition, PECVD) may be applied in the plasma deposition apparatus 100 to form a thin film on a surface of a substrate. In addition, the plasma deposition apparatus 100 described herein is, for instance, employed under the normal pressure.

According to the present exemplary embodiment, the plasma deposition apparatus 100 may alternatively include an air curtain unit 140 connected to the plasma generation unit 110 for generating an air curtain; thereby, plasma PA is prevented from reacting with the environmental air, and the favorable quality of the resultant film may be ensured.

Certainly, the plasma deposition apparatus 100 described herein may also be employed in a vacuum environment or under other circumstances. Said vacuum environment may typically refer to a high vacuum environment or a rough vacuum environment. Based on the actual manufacturing condition, the plasma deposition apparatus 100 may determine whether the air curtain unit 140 is required or not.

The structure of the plasma deposition apparatus provided herein is further described hereinafter. The reference numbers used in the previous exemplary embodiment are further employed below to represent identical or similar elements as well as the connection correlations of these elements.

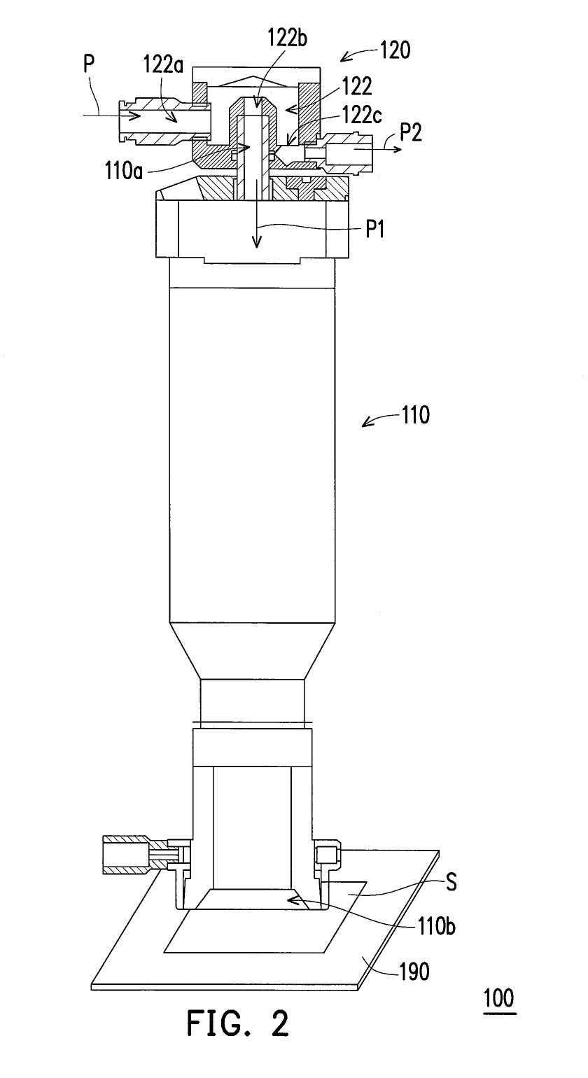

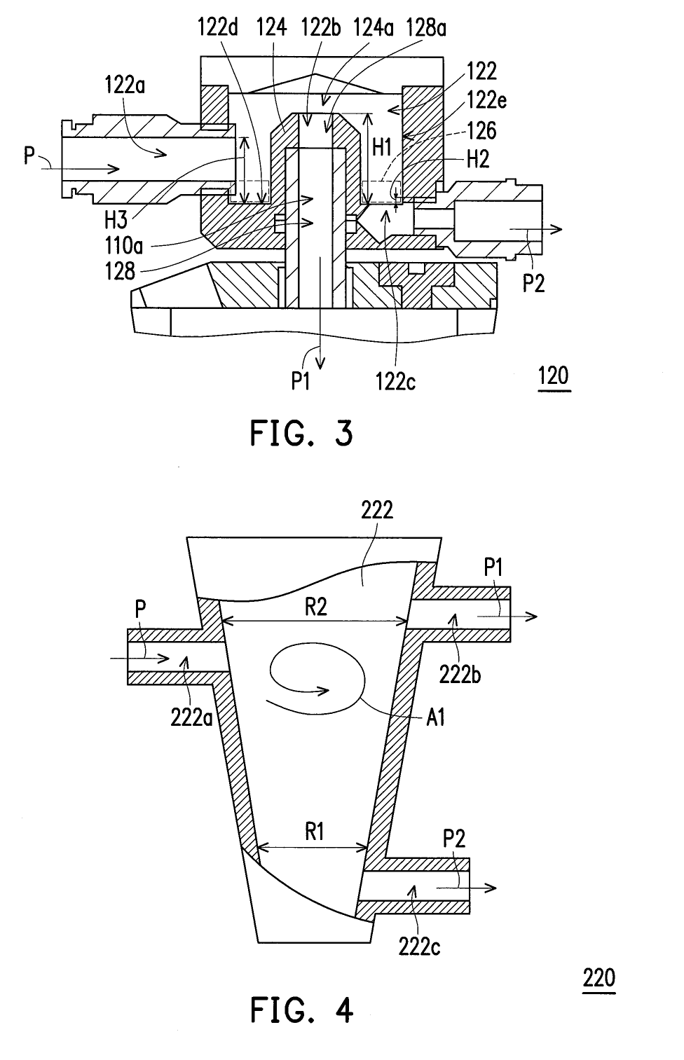

FIG. 2 illustrates a structure of a plasma deposition apparatus according to an exemplary embodiment of the disclosure. FIG. 3 is an enlarged view of the droplet separation unit in FIG. 2. With reference to FIG. 2 and FIG. 3, the plasma deposition apparatus 100 includes the plasma generation unit 110 and the droplet separation unit 120. The plasma generation unit 110 includes an inlet end 110a and an outlet end 110b. The droplet separation unit 120 is located at the inlet end 110a of the plasma generation unit 110. Besides, the droplet separation unit 120 includes a first chamber 122, an import port 122a, and a connection port 122b. The import port 122a and the connection port 122b are connected to the first chamber 122. The connection port 122b is connected to the inlet end 110a of the plasma generation unit 110. The import port 122a is connected to the atomizer 130 for receiving the atomized precursor P. The droplet separation unit 120 further includes an exhaust port 122c, and a portion of the atomized precursor P is allowed to leave the droplet separation unit 120 through the exhaust port 122c.

The atomized precursor P entering the first chamber 122 through the import port 122a has droplets in different sizes. Accordingly, in the droplet separation unit 120, the exhaust port 122c, the import port 122a connected to the first chamber 122, and the connection port 122b connected to the first chamber 122 are arranged in the manner descried below.

In the present exemplary embodiment, a height H1 of the connection port 122b of the droplet separation unit 120 relative to a bottom 122d of the first chamber 122 is substantially greater than a height H2 of the exhaust port 122c of the droplet separation 120 unit relative to the bottom 122d of the first chamber 122. Besides, the height H1 of the connection port 122b of the droplet separation unit 120 relative to the bottom 122d of the first chamber 122 is substantially greater than a height H3 of the import port 122a of the droplet separation unit 120 relative to the bottom 122d of the first chamber 122.

In particular, when the atomized precursor P enters the first chamber 122 through the import port 122a, the atomized precursor P containing the droplets in different sizes are affected by gravity, such that the large droplets of the condensed precursor P fall down to the bottom 122d of the first chamber, and that the small droplets of the atomized precursor P float in the first chamber 122, for instance. Due to the height difference between the connection port 122b and the exhaust port 122c and the height difference between the connection port 122b and the import port 122a, the atomized precursor P containing the droplets in different sizes may be filtered and selected. Besides, in the present exemplary embodiment, the difference between the height H1 and the height H3 ranges from about 1 mm to about 20 mm, for instance.

In the present exemplary embodiment, the droplet separation unit 120 described herein has a protrusion 124 that is located at the bottom 122d of the first chamber 122 and protrudes toward the inside of the first chamber 122. A storage space 126 is formed between the protrusion 124 and a sidewall 122e of the first chamber 122. After separation, the large droplets of the atomized precursor P fall down into the storage space 126 and constitute the second portion P2 of the atomized precursor P. The connection port 122b of the droplet separation unit 120 is located on a top surface 124a of the protrusion 124, and the small droplets of the atomized precursor P floating in the first chamber 122 may enter the connection port 122b and constitute the first portion P1 of the atomized precursor P. The exhaust port 122c of the droplet separation unit 120 is located at the bottom 122d of the storage space 126, and the second portion P2 of the atomized precursor P in the storage space 126 is exhausted through the exhaust port 122c. Here, the second portion P2 of the atomized precursor P may be directly exhausted through the exhaust port 122c; alternatively, the second portion P2 of the atomized precursor P may be guided to the atomizer 130 depicted in FIG. 1 through the exhaust port 122c and may then be recycled for next use.

In the present exemplary embodiment, the droplet separation unit 120 has a first channel 128 that penetrates the protrusion 124. The connection port 122b of the droplet separation unit 120 is located at a top end 128a of the first channel 128, and the inlet end 110a of the plasma generation unit 110 is extended and inserted into the first channel 128. Therefore, the first portion P1 of the atomized precursor P may enter the first channel through the connection portion 122b and may be guided to the inlet end 110a of the plasma generation unit 110 and enter the plasma generation unit 110.

FIG. 4 is a schematic diagram illustrating another droplet separation unit according to an exemplary embodiment of the disclosure. With reference to FIG. 4, in the present exemplary embodiment, the droplet separation unit 220 may achieve the effects similar to those accomplished by the droplet separation unit 120; specifically, the droplet separation unit 220 may separate the droplets of the atomized precursor P in different sizes. Here, the droplet separation unit 220 includes an import port 222a, a connection port 222b, and an exhaust port 222c. The import port 222a is, for instance, connected to the atomizer 130 depicted in FIG. 1 for receiving the atomized precursor P. The connection port 222b is, for instance, connected to the plasma generation unit 110 depicted in FIG. 2. Through a vortex air flow A1, the atomized precursor P is guided to enter the first chamber 222 of the droplet separation unit 220. The first portion P1 of the atomized precursor P containing the small droplets is guided to the connection port 222b, and the second portion P2 of the atomized precursor P containing the large droplets is sunk down to the exhaust port 222c and exhausted from the first chamber 222. In the present exemplary embodiment, the first chamber 222 of the droplet separation unit 220 has a tapered shape, and an inner diameter R1 of the first chamber 222 adjacent to the exhaust port 222c is smaller than an inner diameter R2 of the first chamber 222 adjacent to the import port 222a.

As shown in FIG. 3, after separation, the first portion P1 of the atomized precursor P may be guided to the inlet end 110a of the plasma generation unit 110 through the first channel 128.

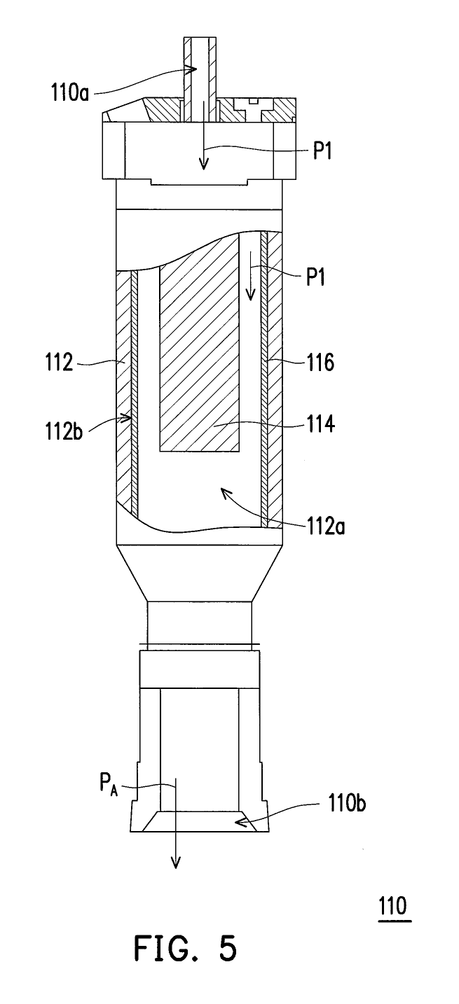

FIG. 5 schematically illustrates the plasma generation unit in FIG. 2. With reference to FIG. 2 and FIG. 5, the plasma generation unit 110 includes a body 112, a first electrode 114, and a second electrode 116. The body 112 has a second chamber 112a that is connected to the inlet end 110a and the outlet end 110b. The first electrode 114 is located inside the second chamber 112a, and the second chamber 112a is connected to the connection port 122b of the first chamber 122 through the inlet end 110a. Therefore, the first portion P1 of the atomized precursor P enters the second chamber 112a through the connection port 122b from the inlet end 110a. The second electrode 116 is located on an inner wall 112b of the second chamber 112a, and the second electrode 116 is opposite to the first electrode 114.

The second electrode 116 described herein is an electrode layer located on the inner wall 112b of the second chamber 112a, for instance. The first electrode 114 and the second electrode 116 are respectively connected to high voltage terminal and ground terminal of a power supply (not shown), for instance, and therefore there may be an electric field between the first electrode 114 and the second electrode 116. When the first portion P1 of the atomized precursor P enters the second chamber 112a, the first portion P1 of the atomized precursor P may be affected by the electric field and may then be dissociated and incorporated into plasma PA. Here, the first electrode 114 is a pillar-shaped electrode composed of conductive metal, for instance, and the second electrode 116 is constituted by conductive metal, for instance.

After the first portion P1 of the atomized precursor P is dissociated into the plasma PA in the second chamber 112a, the first portion P1 of the atomized precursor P is guided to the outlet end 110b and moved away from the plasma generation unit 110. Then, a thin film is formed on an object 190 to be coated, as shown in FIG. 2

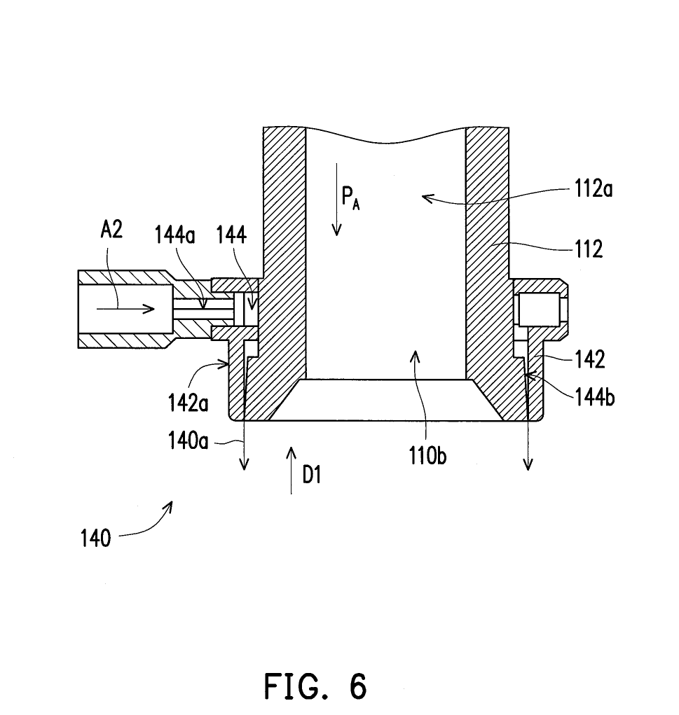

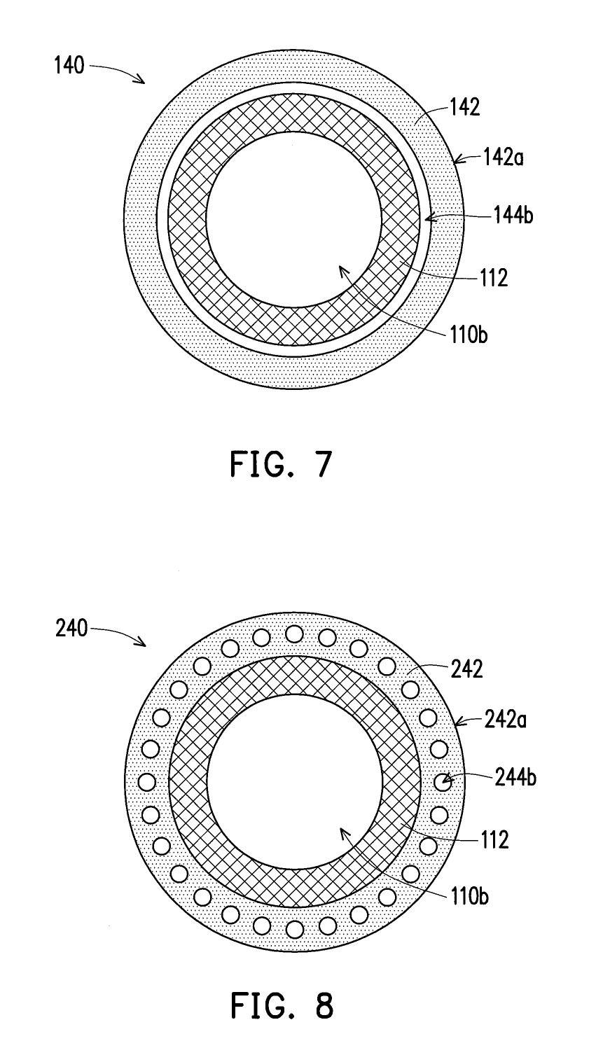

In another exemplary embodiment, an air curtain unit 140 may be alternatively configured at the outlet end 110b. FIG. 6 schematically illustrates the air curtain unit in FIG. 1. FIG. 7 is a bottom view of the air curtain unit in FIG. 6 along a direction D1. As shown in FIG. 6 and FIG. 7, the air curtain unit 140 is located at the outlet end 110b of the plasma generation unit 110 for generating an air curtain 140a. Here, the air curtain 140a surrounds the outlet end 110b of the plasma generation unit 110, and air of the air curtain 140a flows in a downward direction. In the present exemplary embodiment, the air curtain unit 140 includes a cover 142 that surrounds the body 112 of the plasma generation unit 110. The cover 142 has a sidewall 142a, and an air outlet 144b facing downwards and a third chamber 144 are formed between the cover 142 and the body 112.

Here, the air outlet 144b is a ring-shaped slit, for instance. In the present exemplary embodiment, the ring-shaped slit may be a gap between the cover 142 and the outlet end 110b of the body 112. The third chamber 144 is connected to an air inlet 144a and the air outlet 144b of the cover 142, such that air A2 entering the air inlet 144a is exhausted from the ring-shaped slit and constitutes the air curtain 140a. The air curtain 140a may seal a region S where the thin film is to be formed on the object 190 shown in FIG. 2.

In the present exemplary embodiment, the ring-shaped slit (i.e., the air outlet 144b) is not limited to be constituted by the cover 142 and the body 112 collectively, and the location of the ring-shaped slit is not limited to be between the cover 142 and the body 112. For instance, the air inlet 144a, the third chamber 144, and the air outlet 144b may also be formed on the sidewall 142a of the cover 142.

In addition, the shape of the air outlet 144b is not limited to be the ring shape. Any air outlet that may achieve the effects of the air curtain is applicable in this disclosure. FIG. 8 illustrates a design of an air outlet of an air curtain unit according to another exemplary embodiment of the disclosure. In the present exemplary embodiment, the air curtain unit 240 has a plurality of holes surrounding the outlet end 110b, and the holes may serve as the air outlet 244b. Here, the air outlet 244b may refer to holes (e.g., circular holes) that are arranged regularly or irregularly and formed on the sidewall 242a of the cover 242.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A plasma deposition apparatus comprising:
a plasma generation unit comprising an inlet end and an outlet end; and
a droplet separation unit located at the inlet end of the plasma generation unit, the droplet separation unit comprising a first chamber, an import port, and a connection port, the import port and the connection port being connected to the first chamber, the connection port being connected to the inlet end of the plasma generation unit, the import port being configured to receive an atomized precursor, wherein the atomized precursor is separated into a first portion and a second portion after entering the first chamber, droplets of the first portion of the atomized precursor are smaller than droplets of the second portion of the atomized precursor, and the first portion of the atomized precursor enters the inlet end of the plasma generation unit through the connection port of the droplet separation unit.

2. The plasma deposition apparatus as recited in claim 1, wherein the atomized precursor comprises an aqueous solution or an organic solvent.

3. The plasma deposition apparatus as recited in claim 1, wherein the droplet separation unit further comprises an exhaust port, and the second portion of the atomized precursor is allowed to leave the droplet separation unit through the exhaust port.

4. The plasma deposition apparatus as recited in claim 3, wherein a height of the connection port of the droplet separation unit relative to a bottom of the first chamber is substantially greater than a height of the exhaust port of the droplet separation unit relative to the bottom of the first chamber.

5. The plasma deposition apparatus as recited in claim 1, wherein a height of the connection port of the droplet separation unit relative to a bottom of the first chamber is substantially greater than a height of the import port of the droplet separation unit relative to the bottom of the first chamber.

6. The plasma deposition apparatus as recited in claim 1, wherein a height difference between the connection port and the import port of the droplet separation unit ranges from about 1 mm to about 20 mm.

7. The plasma deposition apparatus as recited in claim 1, wherein the droplet separation unit comprises:
a protrusion located at a bottom of the first chamber; and
a first channel penetrating the protrusion, the connection port of the droplet separation unit being located at a top end of the first channel, the inlet end of the plasma generation unit being extended and inserted into the first channel.

8. The plasma deposition apparatus as recited in claim 7, wherein the protrusion protrudes toward an inside of the first chamber, a storage space is formed between the protrusion and a sidewall of the first chamber, the connection port of the droplet separation unit is located on a top surface of the protrusion.

9. The plasma deposition apparatus as recited in claim 3, wherein the first chamber has a tapered shape, and an inner diameter of the first chamber adjacent to the exhaust port of the droplet separation unit is smaller than an inner diameter of the first chamber adjacent to the import port of the droplet separation unit.

10. The plasma deposition apparatus as recited in claim 1, wherein the plasma generation unit comprises:
a body having a second chamber, the second chamber connected to the inlet end and the outlet end of the plasma generation unit;
a first electrode located in the second chamber; and
a second electrode located on an inner wall of the second chamber, the second electrode being opposite to the first electrode.

11. The plasma deposition apparatus as recited in claim 10, further comprising an air curtain unit located at the outlet end of the plasma generation unit for generating an air curtain, wherein the air curtain surrounds the outlet end of the plasma generation unit.

12. The plasma deposition apparatus as recited in claim 11, wherein the air curtain unit comprises a cover surrounding the body of the plasma generation unit, the cover has an air inlet, an air outlet facing downwards and a third chamber are formed between the cover and the body, and the third chamber is connected to the air inlet and the air outlet.

13. The plasma deposition apparatus as recited in claim 12, wherein the air outlet comprises a ring-shaped slit or a plurality of holes surrounding the outlet end of the plasma generation unit.

14. The plasma deposition apparatus as recited in claim 1 further comprising an atomizer unit connected to the import port of the droplet separation unit for providing the atomized precursor.

15. The plasma deposition apparatus as recited in claim 1, further comprising an air curtain unit located at the outlet end of the plasma generation unit for generating an air curtain, wherein the air curtain surrounds the outlet end of the plasma generation unit.
